(19) United States
(12) Patent Application Publication
(10) Pub. No.: US 2025/0202366 A1
(43) Pub. Date: Jun. 19, 2025

(54) CONTROL CIRCUIT AND METHOD FOR ISOLATED SWITCHING-MODE CONVERTER

(71) Applicant: SHANGHAI BRIGHT POWER SEMICONDUCTOR CO., LTD., Shanghai (CN)

(72) Inventors: Pengbo YANG, Shanghai (CN); Zhen ZHU, Shanghai (CN); Yue ZHENG, Shanghai (CN); Yucai YANG, Shanghai (CN); Jianpei ZHU, Shanghai (CN); Zijian LI, Shanghai (CN); Xiaoru GAO, Shanghai (CN); Rulong JIANG, Shanghai (CN); Ge YANG, Shanghai (CN); Shuai WU, Shanghai (CN); Qinyuan TIAN, Shanghai (CN)

(21) Appl. No.: 18/978,496

(22) Filed: Dec. 12, 2024

(30) Foreign Application Priority Data
Dec. 15, 2023 (CN) 202311726752.1

(51) Int. Cl. H02M 3/335; H02M 1/00; H02M 1/08; H02M 1/32

(52) U.S. Cl. CPC H02M 3/33515; H02M 1/0032; H02M 1/32; H02M 3/33592; H02M 1/08

(57) ABSTRACT

A control circuit and method for an isolated switching-mode converter are disclosed. A secondary side controller receives and responds to a sleep control signal to generate a sleep request signal. When the sleep control signal is in a first state, the secondary-side controller enters a sleep mode and switches the sleep request signal to a third state. A primary-side controller responds to the sleep request signal in the third state and enters the sleep mode. In this way, the primary-side controller can enter the sleep mode in response to the entry of the secondary-side controller into the sleep mode. After the primary and second controllers enter the sleep mode, a majority of functional modules therein, as well as a signal isolator between the controllers, are turned off, effectively reducing standby power consumption of the system.

### CROSS-REFERENCE TO RELATED APPLICATION

This application claims the priority of Chinese patent application number 202311726752.1, filed on Dec. 15, 2023 and entitled “CONTROL CIRCUIT AND METHOD FOR ISOLATED SWITCHING-MODE CONVERTER”, the entire contents of which are incorporated herein by reference.

### TECHNICAL FIELD

The present invention relates to the field of electronic circuits, and in particular to a control circuit and method for an isolated switching-mode converter.

### BACKGROUND

Isolated switching-mode converters are widely used in various power supply systems. An isolated switching-mode converter typically includes a primary-side circuit and a secondary-side circuit, and a stable voltage or current output of the secondary-side circuit can be obtained by controlling turn-on and turn-off of power switches in the primary-side and secondary-side circuits.

Further, in a control circuit for the isolated switching-mode converter, a separate isolator is usually provided to enable signal transmission between the primary and secondary sides, and to interlock turn-on of the power transistor switch in the primary-side circuit with the synchronous rectifier transistor in the secondary-side circuit, preventing common conduction of the primary and secondary-side circuits. Despite a simple circuit design and optimized efficiency, this system suffers from significant standby power consumption of the isolator and associated transmitter and receiver circuits. Therefore, further improvements would be desirable to reduce the system's standby power consumption.

### SUMMARY OF THE INVENTION

In view of the above-described disadvantages of the prior art, it is an object of the present invention to provide a control scheme for an isolated switching-mode converter, which overcomes the problem of high standby power consumption associated with conventional isolated switching-mode converters.

The foregoing and further objects are attained by:
a control circuit for an isolated switching-mode converter of the present invention, the isolated switching-mode converter comprising a primary-side circuit, a secondary-side circuit and a transformer coupled between the primary-side circuit and the secondary-side circuit, wherein the control circuit comprises:
a secondary-side controller, wherein the secondary-side controller is electrically connected to the secondary-side circuit and is configured to: receive a sleep control signal; and generate a sleep request signal based on the sleep control signal, and wherein the secondary-side controller generates a sleep request signal in a third state based on the sleep control signal and enters a sleep mode if the sleep control signal is in a first state; and
a primary-side controller, wherein the primary-side controller is electrically connected to the primary-side circuit and is configured to receive the sleep request signal, and wherein the primary-side controller enters the sleep mode if the sleep request signal is in a third state.

Optionally, the secondary-side controller may comprise at least a secondary logic circuit, a detection circuit and a transmitter circuit, wherein the detection circuit is configured to detect and transmit a secondary-side winding voltage in the secondary- side circuit to a secondary logic circuit, wherein the secondary logic circuit is configured to generate the sleep request signal based on the secondary-side winding voltage and the sleep control signal, and wherein the sleep request signal is output to the primary-side controller through the transmitter circuit.

Optionally, the secondary-side controller may further comprise a secondary driver circuit, wherein the secondary logic circuit is configured to generate a secondary control signal and the sleep request signal based on the secondary-side winding voltage and the sleep control signal, wherein the secondary driver circuit is configured to generate, based on the secondary control signal, a secondary switch drive signal for controlling a secondary switch in the secondary-side circuit.

Optionally, the primary-side controller may comprise a primary receiver circuit, an undervoltage protection circuit, a primary logic circuit and a primary driver circuit, wherein the primary receiver circuit is configured to receive and transmit the sleep request signal to the primary logic circuit, wherein the undervoltage protection circuit is electrically connected to the primary-side circuit and is configured to detect a power supply voltage of the primary-side controller to derive an undervoltage protection signal, wherein the primary logic circuit is configured to generate a primary control signal based on the sleep request signal and the undervoltage protection signal, and wherein the primary driver circuit is configured to generate a primary switch drive signal for controlling a primary switch in the primary-side circuit based on the primary control signal.

Optionally, when detecting that the sleep control signal is in the first state, the secondary-side controller turns off the detection circuit, controls the transmitter circuit to operate intermittently, keeps the secondary switch turned off using the secondary switch drive signal and switches the sleep request signal to the third state, thereby enabling the secondary-side controller to enter the sleep mode.

Optionally, when detecting that the sleep control signal is in the first state, the secondary-side controller turns off the detection circuit, controls the transmitter circuit to operate intermittently and switches the sleep request signal to the third state, thereby enabling the secondary-side controller to enter the sleep mode.

Optionally, when detecting that the sleep request signal is in the third state, the primary-side controller turns off the undervoltage protection circuit and the primary driver circuit, and controls the primary receiver circuit to operate intermittently, thereby enabling the primary-side controller to enter the sleep mode.

Optionally, when the primary-side controller and the secondary-side controller enter the sleep mode, the secondary-side controller detects an output voltage of the secondary-side circuit, wherein if the output voltage is below a first threshold, the secondary-side controller enters a partial wake-up mode, and wherein the secondary logic circuit switches the sleep request signal from the third state to a fifth state and transmits the sleep request signal to the primary-side controller through the transmitter circuit.

Optionally, when detecting that the sleep request signal is in the fifth state, the primary-side controller enters the partial wake-up mode, turns on the primary driver circuit, and controls a primary switch to act in response to the sleep request signal to compensate for the output voltage of the secondary-side circuit.

Optionally, in the partial wake-up mode, the secondary-side controller may turn on the detection circuit, wherein when the secondary-side winding voltage is detected to vary in accordance with the sleep request signal, the secondary logic circuit switches the sleep request signal from the fifth state to the third state, thereby enabling the secondary-side controller to return to the sleep mode.

Optionally, when detecting that the sleep control signal is in a second state, the secondary-side controller may enter a wake-up mode and switch the sleep request signal to a fourth state; and when detecting that the sleep request signal is in the fourth state, the primary-side controller may enter the wake-up mode and control the primary switch to act.

Optionally, the secondary-side controller may comprise at least a detection circuit and a transmitter circuit, wherein the detection circuit is configured to detect a secondary-side winding voltage in the secondary-side circuit, wherein the sleep request signal is output to the primary-side controller through the transmitter circuit, wherein when detecting that the sleep control signal is in the second state, the secondary-side controller turns on the detection circuit and the transmitter circuit, thereby enabling the secondary-side controller to enter the wake-up mode.

Optionally, the primary-side controller may comprise a primary receiver circuit, an undervoltage protection circuit, a primary logic circuit and a primary driver circuit, wherein the primary receiver circuit is configured to receive and transmit the sleep request signal to the primary logic circuit, wherein the undervoltage protection circuit is electrically connected to the primary-side circuit and is configured to detect a power supply voltage of the primary-side controller to derive an undervoltage protection signal, wherein the primary logic circuit is configured to generate a primary control signal based on the sleep request signal and the undervoltage protection signal, and wherein the primary driver circuit is configured to generate a primary switch drive signal for controlling a primary switch in the primary-side circuit based on the primary control signal; when the primary logic circuit detects that the sleep request signal is in the fourth state, the primary-side controller turns on the undervoltage protection circuit, the primary driver circuit and the primary receiver circuit, and controls the primary switch to act using the primary switch drive signal, thereby enabling the primary-side controller to enter the wake-up mode.

Optionally, the control circuit may further comprise a signal isolator, wherein the signal isolator is configured to receive the sleep request signal transmitted from the secondary-side controller and to transmit the sleep request signal to the primary-side controller in an isolated manner.

Optionally, the primary-side controller may detect the state of the sleep request signal based on at least one of a count of the sleep request signal over a predetermined period of time, a frequency of the sleep request signal and coded information of the sleep request signal.

There is also provided a control method for an isolated switching-mode converter comprising a primary-side circuit, a secondary-side circuit and a transformer coupled between the primary-side circuit and the secondary-side circuit. The primary-side circuit is controlled by a primary-side controller, and the secondary-side circuit is controlled by a secondary-side controller. The control method comprises:
receiving and responding to a sleep control signal by the secondary-side controller, wherein when detecting that the sleep control signal is in a first state, the secondary-side controller generates a sleep request signal in a third state based on the sleep control signal, and enters a sleep mode; and
receiving and responding to the sleep request signal by the primary-side controller, wherein when detecting that the sleep request signal is in the third state, the primary-side controller enters the sleep mode.

Optionally, the control method may further comprise:
when the primary-side controller and the secondary-side controller enter the sleep mode, detecting an output voltage of the secondary-side circuit;
wherein when detecting that the output voltage is below a first threshold, the secondary-side controller enters a partial wake-up mode and switches the sleep request signal from the third state to a fifth state; and
wherein when detecting that the sleep request signal is in the fifth state, the primary-side controller enters the partial wake-up mode and controls a primary switch to act in response to the sleep request signal to compensate for a power supply voltage of the primary-side controller and the output voltage, so that the output voltage is not lower than the first threshold.

Optionally, the control method may further comprise:
when detecting that the sleep control signal is in a second state, the secondary-side controller enters a wake-up mode and switches the sleep request signal to a fourth state; and
wherein when detecting that the sleep request signal is in the fourth state, the primary-side controller enters the wake-up mode and controls the primary switch to act.

Optionally, the secondary-side controller may comprise at least a secondary logic circuit, a detection circuit and a transmitter circuit, wherein the detection circuit is configured to detect and transmit a secondary-side winding voltage in the secondary-side circuit to the secondary logic circuit, wherein the control method further comprises:
generating the sleep request signal by the secondary logic circuit based on the secondary-side winding voltage and the sleep control signal, wherein the sleep request signal is output to the primary-side controller through the transmitter circuit;
when detecting that the sleep control signal is in the first state, the secondary-side controller turns off the detection circuit, controls the transmitter circuit to operate intermittently and switches the sleep request signal to the third state, thereby enabling the secondary-side controller to enter the sleep mode.

Optionally, the primary-side controller may comprise a primary receiver circuit, an undervoltage protection circuit, a primary logic circuit and a primary driver circuit, the undervoltage protection circuit electrically connected to the primary-side circuit and configured to detect a power supply voltage of the primary-side controller for deriving an undervoltage protection signal, wherein the control method further comprises:
receiving and transmitting the sleep request signal to the primary logic circuit by the primary receiver circuit, generating a primary control signal by the primary logic circuit based on the sleep request signal and the undervoltage protection signal, and generating a primary switch drive signal by the primary driver circuit based on the primary control signal for controlling a primary switch in the primary-side circuit;
wherein when detecting that the sleep request signal is in the third state, the primary-side controller turns off the undervoltage protection circuit and the primary driver circuit, and controls the primary receiver circuit to operate intermittently, thereby enabling the primary-side controller to enter the sleep mode.

Therefore, the control circuit and method of the present invention offer at least the following benefits:

The secondary-side controller receives and responds to a sleep control signal and generates a sleep request signal based on the sleep control signal. When the sleep control signal is in a first state, the secondary-side controller enters a sleep mode and switches the sleep request signal to a third state. The primary-side controller responds to the sleep request signal in the third state and enters the sleep mode. In this way, the primary-side controller can enter the sleep mode in response to the entry of the secondary-side controller into the sleep mode. In the sleep mode, functional modules in the primary and second controllers, which consume much power, are turned off, and the signal isolator between the primary-side and secondary-side circuits, the receiver circuit and transmitter circuit operate intermittently or are turned off, effectively reducing standby power consumption of the system. Further, the sleep control and request signals correspond to each other so that the primary-side controller can exit the sleep mode and enter a partial or full wake-up mode in response to the secondary-side controller exiting the sleep mode and entering the partial or full wake-up mode, ensure a desirable power supply condition for the control circuit and quick wake-up of the system.

### BRIEF DESCRIPTION OF THE DRAWINGS

FIG. 1 is a schematic circuit diagram of an isolated switching-mode converter coupled to a control circuit according to an embodiment of the present invention.

FIG. 2 is a schematic waveform diagram of key signals in an isolated switching-mode converter coupled to a control circuit according to an embodiment of the present invention.

FIG. 3 is a schematic waveform diagram of key signals in an isolated switching-mode converter coupled to a control circuit according to an embodiment of the present invention during its entry from a sleep mode to a partial wake-up mode.

FIG. 4 is a schematic diagram showing steps in a control method for an isolated switching-mode converter according to the present invention.

FIG. 5 is a schematic circuit diagram of an isolated switching-mode converter coupled to a control circuit according to another embodiment of the present invention.

### DETAILED DESCRIPTION

Embodiments of the present invention will be described below by way of specific examples. Based on the disclosure and teachings provided herein, a person of ordinary skill in the art will readily realize other advantages and benefits provided by the present invention. The present invention may also be otherwise embodied or applied through different embodiments, and various modifications or changes may be made to the details disclosed herein from different points of view or for different applications, without departing from the spirit of the present invention.

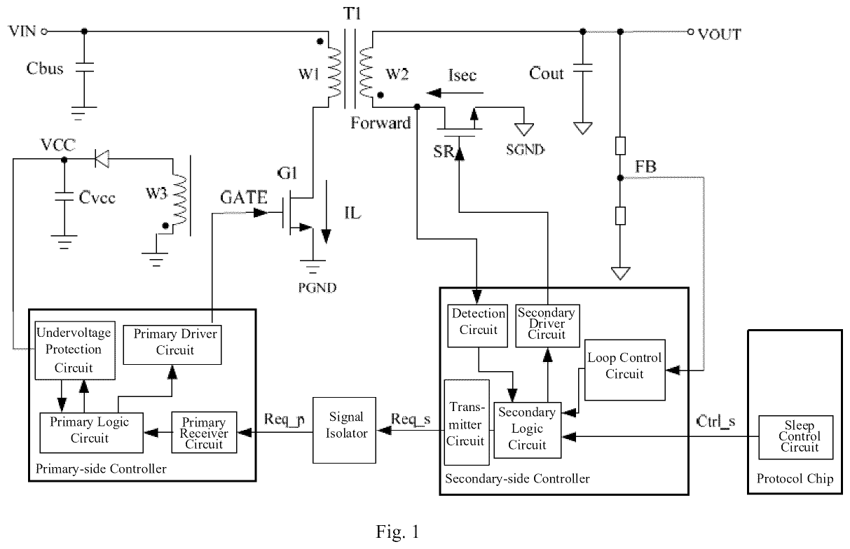

Reference is made to FIGS. 1 to 5 below. It is noted that the accompanying drawings are provided herein merely to schematically illustrate the basic concept of the present invention. Accordingly, they only show components relating to the present invention but not necessarily depict all the components as well as their real shapes and dimensions in practical implementations. In practice, the configurations, numbers and relative scales of the components may vary arbitrarily and their arrangements may be more complicated. As used herein, the term “time” refers to a period of time or an instant, the terms “when” refer to a point of time at which an event occurs. As used herein, the term “high level” refers to a detectable electrical level determined to be valid, which indicates an action to be taken by a specified element or module. As used herein, the term “low level” refers to a detectable electrical level determined to be invalid, or an undetectable electrical level, which indicative of an action to be taken by a specified element or module. As used herein, the term “signal” refers to an electrical/magnetic signal, which can be represented by a particular waveform, or to information transmitted in a circuit, which can be represented by a particular value. These terms are used for the sake of clarity of description only, and are not intended to limit the scope of embodiments of the present invention in any way. Any and all adaptations or variations of their meanings are also intended to be embraced within the scope of embodiments of the invention, if they do not imply any substantive technical modifications.

FIG. 1 is a schematic circuit diagram of an isolated switching-mode converter coupled to a control circuit according to an embodiment of the present invention. It is noted that although the control circuit has been illustrated in FIG. 1 and described below as being used to control a flyback converter, as an example, the present invention is not so limited, because the circuit may also be suitably used with other types of isolated switching-mode converters than the flyback converter of FIG. 1, such as push-pull converter, half-bridge converter, full-bridge converter, forward converter and many other converters.

Specifically, as shown in FIG. 1, the isolated switching-mode converter includes a primary-side circuit, a secondary-side circuit and a transformer T1 coupled between the primary-side and secondary-side circuits to provide electrical isolation. The electrically isolated primary-side and secondary-side circuits are connected to different ground terminals. The transformer T1 includes a primary-side winding W1 and a secondary-side winding W2. The primary-side circuit is coupled to the primary-side winding W1 in the transformer T1, and the secondary-side circuit is coupled to the secondary-side winding W2 in the transformer T1.

More specifically, as shown in FIG. 1, the primary-side circuit includes an input capacitor Cbus and a primary switch G1. A first terminal of the input capacitor Cbus is coupled to the primary-side winding W1 of the transformer T1, and a second terminal of the input capacitor Cbus is connected to the ground terminal for the primary-side circuit. A drain of the primary switch G1 is connected to the primary-side winding W1 of the transformer T1. A source of the primary switch G1 is connected to the ground terminal for the primary-side circuit. A gate of the primary switch G1 is connected to a primary-side controller in order to receive a primary switch drive signal GATE.

Specifically, as shown in FIG. 1, the primary-side circuit further includes an auxiliary winding W3, a diode and a power supply capacitor Cvcc. The auxiliary winding W3 is coupled to the transformer T1. One terminal of the auxiliary winding W3 and one terminal of the power supply capacitor Cvcc are connected to the ground terminal for the primary-side circuit. The other terminal of the power supply capacitor Cvcc is coupled to the other terminal of the auxiliary winding W3 via the diode. Specifically, a cathode of the diode is connected to the power supply capacitor Cvcc, and an anode of the diode is connected to the auxiliary winding W3. In practical applications, the power supply capacitor Cvcc may be charged via the auxiliary winding W3, ensuring that a sufficient power supply voltage VCC is provided to the primary-side controller. Moreover, since the auxiliary winding W3 is coupled to the transformer T1, an output voltage of the auxiliary winding W3 (i.e., the power supply voltage VCC provided by the power supply capacitor Cvcc) is proportional to an output voltage VOUT of the secondary-side circuit. As such, as long as the power supply voltage VCC is kept within an adequate range, it can be ensured that the primary-side controller will operate normally (the primary-side controller can perform its functions according to its design) and that the output voltage VOUT will not be too low. Thus, once the isolated switching-mode converter is woken up, it can swiftly establish the output and start normal operation.

More specifically, as shown in FIG. 1, the secondary-side circuit includes a secondary switch SR, an output capacitor Cout1 and a sampling circuit. A first terminal of the output capacitor Cout1 is coupled to the secondary-side winding W2 of the transformer T1, and a second terminal of the output capacitor Cout is coupled to the ground terminal for the secondary-side circuit. A drain of the secondary switch SR is connected to the secondary-side winding W2 of the transformer T1. A source of the secondary switch SR is connected to the ground terminal for the secondary-side circuit. A gate of the secondary switch SR is connected to a secondary-side controller, in order to receive a secondary switch drive signal. The sampling circuit is connected to an output terminal of the isolated switching-mode converter, in order to sample the converter's output voltage VOUT to form a feedback voltage FB. The feedback voltage FB may directly or indirectly reflect a condition of the output voltage. The sampling circuit may also be electrically connected to the secondary-side controller, in order to allow the feedback voltage FB to be provided to the secondary-side controller. The secondary-side controller may modulate the control signal for the secondary switch SR based on the feedback voltage FB. For example, the sampling circuit may be a resistive voltage-division circuit, as shown in FIG. 1, or an alternative technical solution for voltage/current detection.

Specifically, as shown in FIG. 1, the present invention provides a control circuit for an isolated switching-mode converter. The control circuit includes: a secondary-side controller and a primary-side controller.

The secondary-side controller is electrically connected to the secondary-side circuit to receive a sleep control signal Ctrl_s, and generates a sleep request signal Req_s based on the sleep control signal Ctrl_s. When the sleep control signal Ctrl_s is in a first state, the secondary-side controller enters a sleep mode. When the sleep control signal Ctrl_s is in a second state, the secondary-side controller enters a wake-up mode. The sleep request signal Req_s is converted by a signal isolator into a sleep request signal Req_p, which is then received by the primary-side controller. It is noted that the signals Req_s and Req_p contain the same information but are associated with different reference grounds due to the intervention of the isolator. For the sake of conciseness, they are regarded herein as the same single signal.

The primary-side controller is electrically connected to the primary-side circuit to receive the sleep request signal Req_s. When the sleep request signal Req_s is in a third state, the primary-side controller enters the sleep mode. When the sleep request signal Req_s is in a fourth state, the primary-side controller enters the wake-up mode.

More specifically, as shown in FIG. 1, the secondary-side controller includes at least a secondary logic circuit, a secondary driver circuit, a detection circuit and a transmitter circuit. The secondary logic circuit receives the sleep control signal Ctrl_s and generates the sleep request signal Req_s based on the sleep control signal Ctrl_s. The sleep request signal Req_s is output to the primary-side controller through the transmitter circuit. The detection circuit is configured to detect a secondary-side winding voltage Forward in the secondary-side circuit and transmit it to the secondary logic circuit. The secondary logic circuit receives the sleep control signal Ctrl_s and the secondary-side winding voltage Forward and generates a secondary control signal to the secondary driver circuit. The secondary driver circuit then generates the secondary switch drive signal for driving the secondary switch SR in the secondary-side circuit based on the secondary control signal.

The secondary driver circuit is connected to the gate (or control terminal) of the secondary switch SR, in order to transmit the control signal for the secondary switch to the gate of the secondary switch SR, to turn on or turn off the secondary switch SR. The detection circuit is connected to the secondary-side winding W2, in order to detect the secondary-side winding voltage Forward in the secondary-side circuit.

Specifically, as shown in FIG. 1, the secondary-side controller may further include a loop control circuit which receives the feedback voltage FB from the secondary-side circuit, generates a corresponding control signal and transmits it to the secondary logic circuit. The secondary logic circuit then accordingly adjusts the secondary control signal that controls the secondary switch SR and hence the output voltage VOUT and the feedback voltage FB from the secondary-side circuit.

Specifically, more details are shown in FIG. 1.

The primary-side controller is electrically connected to the primary-side circuit to receive the sleep request signal Req_p. When the sleep request signal Req_p is in a third state, the primary-side controller enters the sleep mode. When the sleep request signal Req_p is in a fourth state, the primary-side controller enters the wake-up mode.

The primary-side controller includes at least a primary receiver circuit, an undervoltage protection circuit, a primary logic circuit and a primary driver circuit. The primary receiver circuit receives the sleep request signal Req_p and passes it on to the primary logic circuit. The undervoltage protection circuit is electrically connected to the primary-side circuit and is configured to detect the power supply voltage VCC of the primary-side controller and derive an undervoltage protection signal. The primary logic circuit generates a primary control signal based on the sleep request signal Req_p and the undervoltage protection signal, and the primary driver circuit generates the primary switch drive signal GATE based on the primary control signal, so as to control the primary switch G1 in the primary-side circuit.

The primary driver circuit is connected to the gate (or control terminal) of the primary switch G1, in order to provide the control signal for the primary switch (e.g., a pulse-width modulated (PWM) signal) to the gate of the primary switch G1, to turn on or turn off the primary switch G1. The undervoltage protection circuit is connected to a terminal of the power supply capacitor Cvcc (this terminal is also connected to the auxiliary winding W3), in order to detect the power supply voltage VCC across the power supply capacitor Cvcc.

Specifically, as shown in FIG. 1, the control circuit further includes the signal isolator, which receives the sleep request signal Req_s from the secondary-side controller, converts it into the sleep request signal Req_p, and transmits the sleep request signal Req_p to the primary-side controller. The signals Req_s and Req_p are isolated from each other.

In practical applications, the signal isolator between the primary-side and secondary-side controllers may be implemented as a magnetic isolator, capacitive isolator, digital isolator or other isolator. The signal isolator consumes very little power in the sleep mode, greatly reducing standby power consumption of the entire system in the sleep mode.

The secondary-side winding voltage Forward sensed by the detection circuit reflects an operating condition of the primary-side circuit, and the secondary-side controller of the present invention can adjust, in response to changes in the secondary-side winding voltage Forward sensed by the detection circuit, the secondary switch drive signal generated by the secondary driver circuit, the operating condition of the secondary-side controller or the like. For example, a response of the primary-side controller to the sleep request signal Req_p can be determined based on the changes in the secondary-side winding voltage Forward, thereby assessing the operating mode of the primary-side circuit.

As described briefly below, in response to entry of the secondary-side controller into the sleep mode, a partial wake-up mode or the wake-up mode, the primary-side controller may also enter the mode.

As shown in FIG. 1, when detecting that the sleep control signal Ctrl_s is in the first state, the secondary-side controller may turn off the detection circuit and control the transmitter circuit to operate intermittently. Moreover, it may maintain the secondary switch SR turned off using the secondary switch drive signal and switch the sleep request signal Req_s to the third state, thereby enabling the secondary-side controller to enter the sleep mode. When detecting that the sleep request signal Req_p is in the third state, the primary-side controller may turn off the undervoltage protection circuit and the primary driver circuit, control the primary receiver circuit to operate intermittently, thereby enabling the primary-side controller to enter the sleep mode.

When the primary-side controller and secondary-side controller enter the sleep mode, the secondary-side controller may detect the output voltage VOUT of the secondary-side circuit and, upon the output voltage VOUT being blow a first threshold (which is lower than a value of the output voltage in normal operation of the switching-mode converter), the secondary-side controller enters the partial wake-up mode. In response, the secondary logic circuit may switch the sleep request signal Req_s from the third state to a fifth state and transmit the sleep request signal Req_s to the primary-side controller through the transmitter circuit. When detecting the fifth state of the sleep request signal Req_p, the primary-side controller may enter the partial wake-up mode, in which the primary driver circuit is turned on to control the primary switch G1 based on the sleep request signal Req_p, thereby compensating for the output voltage VOUT of the secondary-side circuit and the power supply voltage VCC of the primary-side controller.

After the secondary-side controller enters the partial wake-up mode, the detection circuit may be turned on to detect the secondary-side winding voltage Forward in the secondary-side circuit. When the secondary-side winding voltage Forward varies according to the sleep request signal Req_p, it is indicated that the secondary-side winding voltage Forward has been brought into accordance with the primary switch that is being controlled by the sleep request signal Req_p, meaning that the primary switch G1 has succeeded in compensating for the output voltage VOUT of the secondary-side circuit and the power supply voltage VCC of the primary-side controller. Accordingly, the secondary logic circuit may switch the sleep request signal Req_p from the fifth state back to the third state, and the secondary-side controller returns to the sleep mode.

When detecting that the sleep control signal Ctrl_s is in the second state, the secondary-side controller may turn on the detection and transmitter circuits, switch the sleep request signal Req_p to the fourth state and enter the wake-up mode. When detecting the fourth state of the sleep request signal Req_p, the primary logic circuit may turn on the undervoltage protection circuit, the primary driver circuit and the primary receiver circuit and control the primary switch G1 using the drive signal GATE, causing the primary-side controller to enter the wake-up mode.

It is noted that the secondary logic circuit may determine whether the sleep control signal Ctrl_s is in the first or second state based on at least one of the signal levels of the sleep control signal Ctrl_s (at a high or low level) and coded information. The primary logic circuit may determine whether the sleep request signal Req_p is in the third, fourth or fifth state based on at least one of a count of the sleep request signal Req_p over a predetermined period of time, a frequency of the sleep request signal and coded information of the sleep request signal Further, the various functional modules in the primary-side and secondary-side controllers may be turned on and turned off simultaneously by enable signals in response to the sleep control signal Ctrl_s and the sleep request signal Req_p, or by the primary and secondary logic circuits in response to the sleep control signal Ctrl_s and the sleep request signal Req_p.

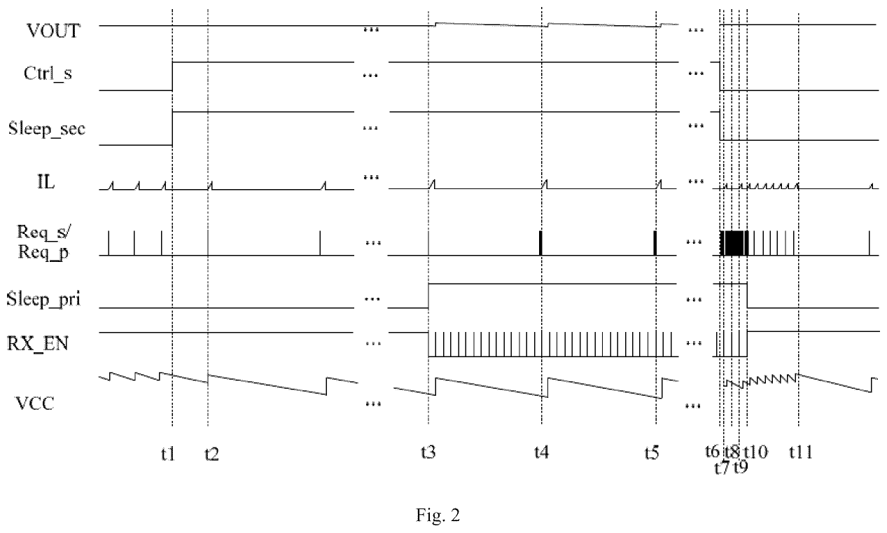

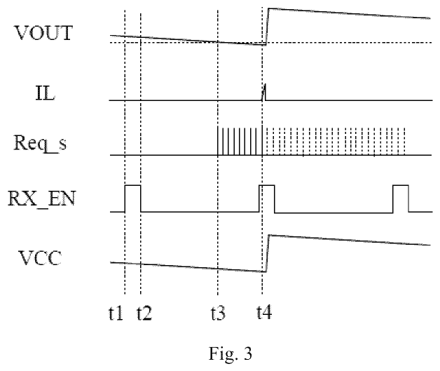

The control principles of the control circuit of FIG. 1 are described in detail below with reference to the waveform timing diagrams of FIGS. 2 to 3.

At time t1, the sleep control signal Ctrl_s provided by a protocol chip to the secondary-side controller transitions from a low level (indicative of the second state of the sleep control signal Ctrl_s) to a high level (indicative of the first state of the sleep control signal Ctrl_s), instructing the secondary-side controller to enter the sleep mode. Responsively, the secondary-side controller turns off the detection circuit and causes the transmitter circuit to operate intermittently. Moreover, it maintains the secondary switch SR turned off using the secondary switch drive signal and switches the sleep request signal Req_p to the third state. As a result, the output voltage VOUT of the secondary-side circuit transitions from the value in normal operation to the first threshold. In another embodiment, the secondary-side controller generates a signal Sleep_sec based on the sleep control signal Ctrl_s, as shown in FIG. 2, which turns off the detection circuit, causes the transmitter circuit to operate intermittently and keeps the secondary switch SR turned off, simultaneously. It is noted that the protocol chip of the present invention may be either a protocol module integrated with the secondary-side controller within a single package, or a separately packaged and used component. The present invention is not limited to any particular protocol embodied in the protocol chip, and any protocol capable of providing the sleep control signal Ctrl_s that can be identified by the secondary-side controller may be suitably used. Without limiting the present invention, the sleep control signal Ctrl_s may be derived from a load port condition detected by the protocol chip, or provided by a microcontroller or another communication channel.

At t2, the secondary-side controller delivers a first pulse of the sleep request signal Req_s in the sleep mode. In this mode, the sleep request signal Req_s sent from the secondary-side controller has a relatively low frequency, indicating that the sleep request signal Req_s is in the third state.

At t3, the primary-side controller detects a low frequency of the sleep request signal Req_p within a predefined range over a number of consecutive periods and enters the sleep mode in response to the sleep request signal Req_p. To this end, it turns off the undervoltage protection circuit and the primary driver circuit and causes the primary receiver circuit to operate intermittently. For example, in each 1-ms period, it may operate for 64 μs and sleep all the remaining time. In this way, a reduction in power consumption can be obtained. As the primary driver circuit is not active, the primary switch G1 is turned off, resulting in a reduction in power consumption of the primary-side controller. In one embodiment, the primary-side controller generates a signal Sleep_pri in response to the sleep request signal Req_p, as shown in FIG. 2, which turns off the undervoltage protection circuit and the primary driver circuit simultaneously and causes the primary receiver circuit to operate intermittently. In another embodiment, an enable signal RX_EN is used to cause the primary receiver circuit to operate intermittently. As shown in FIG. 2, a high level of the enable signal RX_EN indicates a normal operation of the primary receiver circuit, and short pulses in the enable signal RX_EN indicates that the primary receiver circuit operates intermittently. For example, in each 1-ms period, the primary receiver circuit may operate for 64 μs and sleep all the remaining time.

From t3 to t6, both the secondary and primary-side controllers are in the sleep mode, and the control circuit consumes less power in the sleep (or standby) mode.

Further, after the secondary-side controller enters the sleep mode, the secondary-side controller detects the output voltage VOUT of the secondary-side circuit in real time. When the output voltage VOUT of the secondary-side circuit is below the first threshold (e.g., 4 V), the secondary-side controller enters the partial wake-up mode. Referring to FIG. 3, upon detecting VOUT dropping to the first threshold at t4, the secondary-side controller delivers a pulse burst consisting of a number of short pulses with a fixed interval as the sleep request signal Req_s (indicating the fifth state of the sleep request signal Req_p, wherein the interval and number of the pulses are adjustable).

It is noted that, in order to additionally lower power consumption, in the sleep mode, the secondary-side controller may intermittently detect the output voltage VOUT of the secondary-side circuit. In this case, when the intermittently-operating primary receiver circuit receives a short pulse of the sleep request signal Req_p during the normal operation of the signal RX_EN, i.e., at the high level thereof, the primary-side controller may turn on the primary transistor switch in response to the short pulse, creating a spike in a primary current IL, for example, as shown at t4. After the secondary-side controller detects the response of the primary-side controller from the winding voltage Forward, it may selectively stop providing the sleep request signal Req_s that is in the fifth state and start providing the sleep request signal Req_s that is in the third state that indicates entry into the sleep mode. After t4, since the primary transistor switch has been turned on for a period of time and some energy has been therefore transmitted from the input side of the switching-mode converter to its output side, the voltage VCC experiences a rise. It is noted that, in order for better control to be achieved, the third state of the sleep request signal Req_s and the fifth state of the sleep request signal Req_s delivered from the secondary-side controller may use the same pulse burst, and when the secondary-side controller detects the response of the primary-side controller to the pulse burst from the winding voltage Forward, it may selectively give up delivery of any pulses in the pulse burst that have not been delivered yet. In the time interval after the secondary-side controller enters the sleep mode and before the primary-side controller enters the sleep mode (e.g., t2-t3 of FIG. 2), the receiver circuit of the primary-side controller is in normal operation, and once it receives a first pulse in any pulse burst, it may responsively turn on the primary transistor switch. Moreover, when the secondary-side controller detects the response of the primary-side controller to the pulse burst from the winding voltage Forward, it may give up delivery of any pulses in the pulse burst that have not been delivered yet. In this way, the output voltage can be maintained around the first threshold (e.g., 4 V). Key waveforms involved in control using the sleep request signal Req_s and the above discussed method are also as shown in FIG. 2.

With continued reference to FIG. 2, at t4, the primary-side controller receives and responds to the sleep request signal Req_s that is in the fifth state from the secondary-side controller. It is noted that the primary-side controller may be only partially woken up in response to the sleep request signal Req_p in the fifth state by turning on the primary driver circuit, which then controls the primary switch G1 (i.e., turns it on or off) to compensate for the power supply voltage VCC of the primary-side controller and the output voltage VOUT of the secondary-side circuit.

At t5, with similarity to the actions taken at t4, the secondary-side and primary-side controllers enter the partial wake-up mode from the sleep mode to compensate for the power supply voltage VCC of the primary-side controller and the output voltage VOUT of the secondary-side circuit, stabilizing the output voltage VOUT of the secondary-side circuit substantially at 4 V.

At t6, the sleep control signal Ctrl_s sent from the protocol chip transitions from the high level (indicating the first state of the sleep control signal Ctrl_s) to the low level (indicating the second state of the sleep control signal Ctrl_s), and the secondary-side controller responsively enters the wake-up mode. To this end, it turns on the detection circuit and the transmitter circuits. After being woken up, the secondary-side controller tunes the output voltage VOUT of the secondary-side circuit back to the value in normal operation (e.g., 5 V) and switches the sleep request signal Req_s to the fourth state and delivers a number of pulses of the sleep request signal Req_s (which represent the fourth state of the sleep request signal Req_s). At this point, the frequency of the pulse of the sleep request signal Req_s can be higher than the frequency of the pulse of the sleep request signal Req_s in sleep mode.

At t7, the primary receiver circuit remains operating intermittently, and the primary-side controller receives and response to a pulse in the sleep request signal Req_p transmitted from the secondary-side controller, and counting as 1.

At t8, the primary receiver circuit remains operating intermittently, and the primary-side controller receives the sleep request signal Req_p in a second consecutive wake-up window. It may selectively respond or not, but increments the counter to 2. In the example of FIG. 2, the primary-side controller does not respond.

At t9, the primary receiver circuit remains operating intermittently, and the primary-side controller receives the sleep request signal Req_p in a third consecutive wake-up window. It may selectively respond or not, but increments the counter to 3. In the example of FIG. 2, the primary-side controller responds to the pulse in the sleep request signal Req_p.

At t10, the primary receiver circuit remains operating intermittently, and the primary-side controller receives the sleep request signal Req_p in a fourth consecutive wake-up window. In response, the primary-side controller exits the sleep mode and enters the wake-up mode, and the undervoltage protection circuit, the primary driver circuit and the primary receiver circuit are turned on. Accordingly, the primary switch G1 resumes normal operation under the control of the primary switch drive signal GATE in response to the sleep request signal Req_p.

At t11, the output voltage VOUT of the secondary-side circuit rises back to 5 V, and the sleep stage ends.

It is noted that the primary-side controller may exit the sleep mode and enter the wake-up mode based on any of multiple alternative criteria, such as a count over a period of time, coding the sleep request signal Req_p, and a detected frequency of the sleep request signal Req_p. In addition, as shown in FIG. 2, the primary-side and secondary-side controllers may follow a process to exit the sleep mode, which is similar to the above-described process to enter the sleep mode. That is, the primary sleep control signal Sleep_pri may be used to turn on the undervoltage protection circuit and the primary driver circuit simultaneously and control normal operation of the primary receiver circuit (e.g., by causing the primary sleep control signal Sleep_pri to transition from the high level to the low level at t10). Moreover, the secondary sleep control signal Sleep_sec may be used to simultaneously control turn-on of the detection circuit and normal operation of the transmitter circuit (e.g., by causing the secondary sleep control signal Sleep_sec to transition from the high level to the low level at t6).

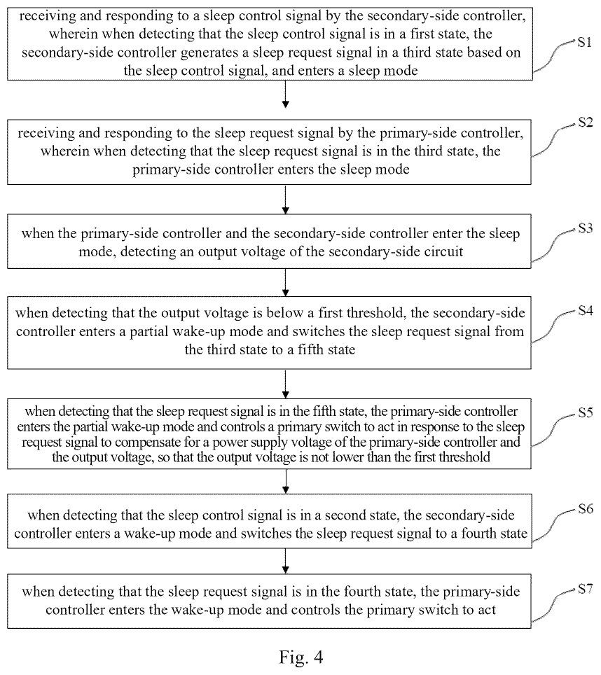

On the basis of the same design concept as the control circuit as discussed above, as shown in FIG. 4, the present invention also provides a control method for an isolated switching-mode converter comprising a primary-side circuit, a secondary-side circuit and a transformer coupled between the primary-side and secondary-side circuits. The primary-side circuit is controlled by a primary-side controller, and the secondary-side circuit is controlled by a secondary-side controller. The method includes the steps of:
S1: receiving and responding to a sleep control signal by the secondary-side controller, wherein when detecting that the sleep control signal is in a first state, the secondary-side controller generates a sleep request signal in a third state based on the sleep control signal, and enters a sleep mode;
S2: receiving and responding to the sleep request signal by the primary-side controller, wherein when detecting that the sleep request signal is in the third state, the primary-side controller enters the sleep mode;
S3: when the primary-side controller and the secondary-side controller enter the sleep mode, detecting an output voltage of the secondary-side circuit;
S4: when detecting that the output voltage is below a first threshold, the secondary-side controller enters a partial wake-up mode and switches the sleep request signal from the third state to a fifth state;
S5: when detecting that the sleep request signal is in the fifth state, the primary-side controller enters the partial wake-up mode and controls a primary switch to act in response to the sleep request signal to compensate for a power supply voltage of the primary-side controller and the output voltage of the secondary-side circuit, so that the output voltage of the secondary-side circuit is not lower than the first threshold;
S6: when detecting that the sleep control signal is in a second state, the secondary-side controller enters a wake-up mode and switches the sleep request signal to a fourth state; and
S7: when detecting that the sleep request signal is in the fourth state, the primary-side controller enters the wake-up mode and controls the primary switch to act.

For more details of the steps in the control method, reference can be made to the above description in connection with the operating principles of the control circuit, and further description thereof is therefore thought to be unnecessary.

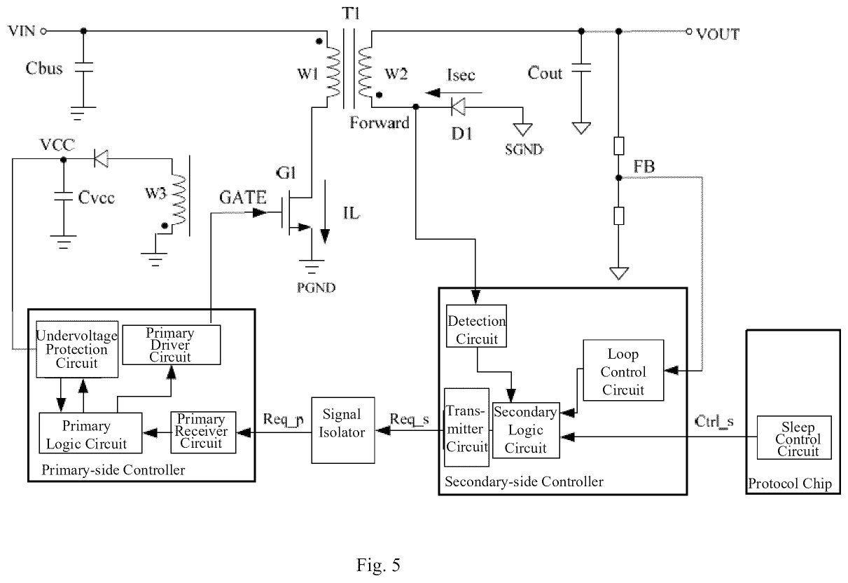

On the basis of the same design concept as the control circuit as discussed above, as shown in FIG. 5, the present invention provides another control circuit for an isolated switching-mode converter. This control circuit differs from the embodiment of FIG. 1 in that the secondary-side circuit in the isolated switching-mode converter includes a freewheeling diode D1 and the output capacitor Cout in place of the synchronous rectifier transistor SR (i.e., the secondary switch SR). An anode of the freewheeling diode D1 is coupled to the ground terminal for the secondary-side circuit, and a cathode thereof is coupled to the terminal of the secondary-side winding W2, where Forward is tapped. Accordingly, the secondary-side controller in the control circuit includes the detection circuit, the secondary logic circuit, the transmitter circuit and the loop control circuit but not the secondary driver circuit. In the embodiment of FIG. 5, after the secondary-side controller enters the sleep mode, it is not necessary to turn off the synchronous rectifier transistor SR, and the freewheeling diode D1 in the secondary-side circuit functions in place of the synchronous rectifier transistor SR in the embodiment of FIG. 1. For more details of operation of this control circuit, reference can be made to the above description in connection with FIGS. 2 to 4 and the operating principles of the above control circuit, and further description thereof is therefore thought to be unnecessary.

In summary, in the control circuits and method of the present invention, the secondary-side controller receives and responds to a sleep control signal and generates a sleep request signal. When the sleep control signal is in a first state, the secondary-side controller enters a sleep mode and switches the sleep request signal to a third state. The primary-side controller responds to the sleep request signal in the third state and enters the sleep mode. In this way, the primary-side controller can enter the sleep mode in response to the entry of the secondary-side controller into the sleep mode. After the primary and second controllers enter the sleep mode, a majority of the functional modules therein, as well as the signal isolator between the controllers, are turned off or operated intermittently, effectively reducing standby power consumption of the system. Further, the sleep control and request signals correspond to each other so that the primary-side controller can enter a wake-up mode in response to entry of the secondary-side controller into the wake-up mode, ensuring that the whole system can be quickly woken up.

The embodiments disclosed hereinabove are solely for the purpose of exemplary illustration of the principles and benefits of the present invention and not for the purpose of limiting the invention. Any person familiar with the art can make modifications or changes to the disclosed embodiments without departing from the spirit and scope of this invention. Accordingly, any and all equivalent modifications or changes made by any person with general common knowledge in the art without departing from the spirit and teachings of the present application are intended to be embraced within the scope as defined by the appended claims.

What is claimed is:

1. A control circuit for an isolated switching-mode converter, wherein the isolated switching-mode converter comprises a primary-side circuit, a secondary-side circuit and a transformer coupled between the primary-side circuit and the secondary-side circuit, and wherein the control circuit comprises:
a secondary-side controller, wherein the secondary-side controller is electrically connected to the secondary-side circuit and is configured to: receive a sleep control signal; and generate a sleep request signal based on the sleep control signal, and wherein the secondary-side controller generates a sleep request signal in a third state based on the sleep control signal and enters a sleep mode if the sleep control signal is in a first state; and
a primary-side controller, wherein the primary-side controller is electrically connected to the primary-side circuit and is configured to receive the sleep request signal, and wherein the primary-side controller enters the sleep mode if the sleep request signal is in a third state.

2. The control circuit according to claim 1, wherein the secondary-side controller comprises at least a secondary logic circuit, a detection circuit and a transmitter circuit, wherein the detection circuit is configured to detect and transmit a secondary-side winding voltage in the secondary-side circuit to a secondary logic circuit, wherein the secondary logic circuit is configured to generate the sleep request signal based on the secondary-side winding voltage and the sleep control signal, and wherein the sleep request signal is output to the primary-side controller through the transmitter circuit.

3. The control circuit according to claim 2, wherein the secondary-side controller further comprises a secondary driver circuit, wherein the secondary logic circuit is configured to generate a secondary control signal and the sleep request signal based on the secondary-side winding voltage and the sleep control signal, wherein the secondary driver circuit is configured to generate, based on the secondary control signal, a secondary switch drive signal for controlling a secondary switch in the secondary-side circuit.

4. The control circuit according to claim 1, wherein the primary-side controller comprises a primary receiver circuit, an undervoltage protection circuit, a primary logic circuit and a primary driver circuit, wherein the primary receiver circuit is configured to receive and transmit the sleep request signal to the primary logic circuit, wherein the undervoltage protection circuit is electrically connected to the primary-side circuit and is configured to detect a power supply voltage of the primary-side controller to derive an undervoltage protection signal, wherein the primary logic circuit is configured to generate a primary control signal based on the sleep request signal and the undervoltage protection signal, and wherein the primary driver circuit is configured to generate a primary switch drive signal for controlling a primary switch in the primary-side circuit based on the primary control signal.

5. The control circuit according to claim 3, wherein when detecting that the sleep control signal is in the first state, the secondary-side controller turns off the detection circuit, controls the transmitter circuit to operate intermittently, keeps the secondary switch turned off using the secondary switch drive signal and switches the sleep request signal to the third state, thereby enabling the secondary-side controller to enter the sleep mode.

6. The control circuit according to claim 2, wherein when detecting that the sleep control signal is in the first state, the secondary-side controller turns off the detection circuit, controls the transmitter circuit to operate intermittently and switches the sleep request signal to the third state, thereby enabling the secondary-side controller to enter the sleep mode.

7. The control circuit according to claim 4, wherein when detecting that the sleep request signal is in the third state, the primary-side controller turns off the undervoltage protection circuit and the primary driver circuit, and controls the primary receiver circuit to operate intermittently, thereby enabling the primary-side controller to enter the sleep mode.

8. The control circuit according to claim 2, wherein when the primary-side controller and the secondary-side controller enter the sleep mode, the secondary-side controller detects an output voltage of the secondary-side circuit, wherein if the output voltage is below a first threshold, the secondary-side controller enters a partial wake-up mode, and wherein the secondary logic circuit switches the sleep request signal from the third state to a fifth state and transmits the sleep request signal to the primary-side controller through the transmitter circuit.

9. The control circuit according to claim 8, wherein when detecting that the sleep request signal is in the fifth state, the primary-side controller enters the partial wake-up mode, turns on the primary driver circuit, and controls a primary switch to act in response to the sleep request signal to compensate for the output voltage of the secondary-side circuit.

10. The control circuit according to claim 8, wherein in the partial wake-up mode, the secondary-side controller turns on the detection circuit, wherein when the secondary-side winding voltage is detected to vary in accordance with the sleep request signal, the secondary logic circuit switches the sleep request signal from the fifth state to the third state, thereby enabling the secondary-side controller to return to the sleep mode.

11. The control circuit according to claim 1, further comprising:
wherein when detecting that the sleep control signal is in a second state, the secondary-side controller enters a wake-up mode and switches the sleep request signal to a fourth state; and
wherein when detecting that the sleep request signal is in the fourth state, the primary-side controller enters the wake-up mode and controls the primary switch to act.

12. The control circuit according to claim 11, wherein the secondary-side controller comprises at least a detection circuit and a transmitter circuit, wherein the detection circuit is configured to detect a secondary-side winding voltage in the secondary-side circuit, wherein the sleep request signal is output to the primary-side controller through the transmitter circuit, wherein when detecting that the sleep control signal is in the second state, the secondary-side controller turns on the detection circuit and the transmitter circuit, thereby enabling the secondary-side controller to enter the wake-up mode.

13. The control circuit according to claim 11, wherein the primary-side controller comprises a primary receiver circuit, an undervoltage protection circuit, a primary logic circuit and a primary driver circuit, wherein the primary receiver circuit is configured to receive and transmit the sleep request signal to the primary logic circuit, wherein the undervoltage protection circuit is electrically connected to the primary-side circuit and is configured to detect a power supply voltage of the primary-side controller to derive an undervoltage protection signal, wherein the primary logic circuit is configured to generate a primary control signal based on the sleep request signal and the undervoltage protection signal, and wherein the primary driver circuit is configured to generate a primary switch drive signal for controlling a primary switch in the primary-side circuit based on the primary control signal;
wherein when the primary logic circuit detects that the sleep request signal is in the fourth state, the primary-side controller turns on the undervoltage protection circuit, the primary driver circuit and the primary receiver circuit, and controls the primary switch to act using the primary switch drive signal, thereby enabling the primary-side controller to enter the wake-up mode.

14. The control circuit according to claim 1, further comprising a signal isolator, wherein the signal isolator is configured to receive the sleep request signal transmitted from the secondary-side controller and to transmit the sleep request signal to the primary-side controller in an isolated manner.

15. The control circuit according to claim 1, wherein the primary-side controller detects a state of the sleep request signal based on at least one of a count of the sleep request signal over a predetermined period of time, a frequency of the sleep request signal and coded information of the sleep request signal.

16. A control method for an isolated switching-mode converter, wherein the isolated switching-mode converter comprises a primary-side circuit, a secondary-side circuit and a transformer coupled between the primary-side circuit and the secondary-side circuit, wherein the primary-side circuit is controlled by a primary-side controller, and the secondary-side circuit is controlled by a secondary-side controller, and wherein the control method comprises:
receiving and responding to a sleep control signal by the secondary-side controller, wherein when detecting that the sleep control signal is in a first state, the secondary-side controller generates a sleep request signal in a third state based on the sleep control signal, and enters a sleep mode; and
receiving and responding to the sleep request signal by the primary-side controller, wherein when detecting that the sleep request signal is in the third state, the primary-side controller enters the sleep mode.

17. The control method according to claim 16, further comprising:
wherein when the primary-side controller and the secondary-side controller enter the sleep mode, detecting an output voltage of the secondary-side circuit;
wherein when detecting that the output voltage is below a first threshold, the secondary-side controller enters a partial wake-up mode and switches the sleep request signal from the third state to a fifth state; and
wherein when detecting that the sleep request signal is in the fifth state, the primary-side controller enters the partial wake-up mode and controls a primary switch to act in response to the sleep request signal to compensate for a power supply voltage of the primary-side controller and the output voltage, so that the output voltage is not lower than the first threshold.

18. The control method according to claim 16, further comprising:
wherein when detecting that the sleep control signal is in a second state, the secondary-side controller enters a wake-up mode and switches the sleep request signal to a fourth state; and
wherein when detecting that the sleep request signal is in the fourth state, the primary-side controller enters the wake-up mode and controls the primary switch to act.

19. The control method according to claim 16, wherein the secondary-side controller comprises at least a secondary logic circuit, a detection circuit and a transmitter circuit, wherein the detection circuit is configured to detect and transmit a secondary-side winding voltage in the secondary-side circuit to the secondary logic circuit, and wherein the control method further comprises:
generating the sleep request signal by the secondary logic circuit based on the secondary-side winding voltage and the sleep control signal, wherein the sleep request signal is output to the primary-side controller through the transmitter circuit;
wherein when detecting that the sleep control signal is in the first state, the secondary-side controller turns off the detection circuit, controls the transmitter circuit to operate intermittently and switches the sleep request signal to the third state, thereby enabling the secondary-side controller to enter the sleep mode.

20. The control method according to claim 16, wherein the primary-side controller comprises a primary receiver circuit, an undervoltage protection circuit, a primary logic circuit and a primary driver circuit, wherein the undervoltage protection circuit is electrically connected to the primary-side circuit and is configured to detect a power supply voltage of the primary-side controller for deriving an undervoltage protection signal, and wherein the control method further comprises:
receiving and transmitting the sleep request signal to the primary logic circuit by the primary receiver circuit, generating a primary control signal by the primary logic circuit based on the sleep request signal and the undervoltage protection signal, and generating a primary switch drive signal by the primary driver circuit based on the primary control signal for controlling a primary switch in the primary-side circuit;
wherein when detecting that the sleep request signal is in the third state, the primary-side controller turns off the undervoltage protection circuit and the primary driver circuit, and controls the primary receiver circuit to operate intermittently, thereby enabling the primary-side controller to enter the sleep mode.
